(19) United States
(12) Patent Application Publication
(10) Pub. No.: US 2016/0281515 A1
(43) Pub. Date: Sep. 29, 2016

(54) METHOD OF ATTACHING A CERAMIC MATRIX COMPOSITE ARTICLE

(71) Applicant: UNITED TECHNOLOGIES CORPORATION, Farmington, CT (US)

(72) Inventor: James A. Dierberger, Hebron, CT (US)

(21) Appl. No.: 15/035,249

(22) PCT Filed: Nov. 3, 2014
(86) PCT No.: PCT/US2014/063662

§ 371 Date: May 9, 2016

Related U.S. Application Data
(60) Provisional application No. 61/905,388, filed on Nov. 18, 2013.

(51) Int. Cl. F01D 5/32; F02K 3/06; F04D 29/64; F01D 5/30; F04D 29/32; F04D 29/34; F02C 3/04; F01D 5/02

(52) U.S. Cl. CPC F01D 5/326; F02C 3/04; F02K 3/06; F01D 5/02; F01D 5/3007; F04D 29/322; F04D 29/325; F04D 29/34; F04D 29/644; F05D 2220/32; F05D 2240/35; F05D 2260/30; F05D 2300/6033; F05D 2300/10; F05D 2230/60; F05D 2230/30

(57) ABSTRACT

A rotor of a turbine engine includes a mounting slot for receiving a blade. The example blade is formed from a ceramic material and is received within the mounting slot. An intumescent material is disposed within the mounting slot between the blade and an inner surface of the mounting slot and expanded by the application of heat for securing the blade within the mounting slot.

### REFERENCE TO RELATED APPLICATION

This application claims priority to U.S. Provisional Application No. 61/905,388 filed on Nov. 18, 2013.

### BACKGROUND

A gas turbine engine typically includes a fan section, a compressor section, a combustor section and a turbine section. Air entering the compressor section is compressed and delivered into the combustion section where it is mixed with fuel and ignited to generate a high-energy exhaust gas flow. The high-speed exhaust gas flow expands through the turbine section to drive the compressor and the fan section. The compressor section typically includes low and high pressure compressors, and the turbine section includes low and high pressure turbines.

The high-energy exhaust gas flow is at an elevated temperature and therefore components within the exhaust gas flow either require higher temperature capable materials and/or cooling features. Cooling air may be extracted from cooler portions of the engine and directed to the hotter sections such as the turbine section. Cooling air extracted from other parts of the engine reduce overall engine efficiency. Accordingly, the use of materials that require little to no cooling air such as ceramic matrix composite materials become a desirable alternative to metal alloys. Ceramic materials provide the desired temperature capabilities but can be susceptible to cracking when mounted to a metal support structures such as metal rotor.

Turbine engine manufacturers continue to seek further improvements to engine performance including improvements to thermal, transfer and propulsive efficiencies.

### SUMMARY

A rotor assembly for a gas turbine engine according to an exemplary embodiment of this disclosure, among other possible things includes a rotor including a mounting slot, a blade formed from a ceramic material and received within the mounting slot, and an intumescent material disposed within the mounting slot between the blade and an inner surface of the mounting slot in an expanded condition for securing the blade within the mounting slot.

In a further embodiment of any of the foregoing rotor assemblies, a clearance is provided between the blade and the inner surface of the mounting slot and the intumescent material is disposed within the clearance.

In a further embodiment of any of the foregoing rotor assemblies, the intumescent material is expanded within the clearance to fill inconsistences in the blade and the inner surface of the mounting slot.

In a further embodiment of any of the foregoing rotor assemblies, the mounting slot includes a shape configured for retaining the blade and the blade includes a corresponding shape for receipt into the slot.

In a further embodiment of any of the foregoing rotor assemblies, the rotor includes a forward stop and an aft stop for preventing axial movement of the blade and the intumescent material is disposed on corresponding forward and aft surfaces of the blade.

In a further embodiment of any of the foregoing rotor assemblies, the rotor includes a turbine rotor and the blade includes a turbine blade.

In a further embodiment of any of the foregoing rotor assemblies, the rotor includes a compressor rotor and the blade includes a compressor blade.

In a further embodiment of any of the foregoing rotor assemblies, the rotor includes a fan rotor and the blade includes a fan blade.

In a further embodiment of any of the foregoing rotor assemblies, the blade includes a blade root received within the mounting slot and at least the blade root is formed from a ceramic material.

In a further embodiment of any of the foregoing rotor assemblies, the ceramic material includes a ceramic matrix composite.

In a further embodiment of any of the foregoing rotor assemblies, the rotor includes a metal material.

A method of fabricating a rotor assembly of a gas turbine engine according to an exemplary embodiment of this disclosure, among other possible things includes applying an intumescent material to one of a blade mounting surface and an inner surface of a mounting slot of a rotor, assembling a blade into the mounting slot, and expanding the intumescent material by heating to fill a clearance between the blade mounting surface and the inner surface of the mounting slot.

In a further embodiment of any of the foregoing methods, includes fabricating a blade from a ceramic material.

In a further embodiment of any of the foregoing methods, includes fabricating the blade from a ceramic matrix composite.

In a further embodiment of any of the foregoing methods, includes forming the rotor from a metal material.

In a further embodiment of any of the foregoing methods, includes defining a clearance between the mounting slot of the rotor and the mounting surface of the rotor and filling the clearance with the intumescent material.

In a further embodiment of any of the foregoing methods, includes heating the rotor, blade and intumescent material to expand the intumescent material and secure the blade within the mounting slot.

A turbine engine according to an exemplary embodiment of this disclosure, among other possible things includes a fan section including a fan rotor supporting a plurality of fan blades rotatable about an axis. A compressor section includes a compressor rotor supporting a plurality of compressor blades. A combustor is in fluid communication with the compressor section. A turbine section is in fluid communication with the combustor. The turbine section includes a turbine rotor supporting a plurality of turbine blades. An intumescent material in an expanded condition secures at least one of the plurality of turbine blades, compressor blades and fan blades within a corresponding one of the turbine rotor, compressor rotor and fan rotor.

In a further embodiment of any of the foregoing turbine engines, the at least one of the plurality of turbine blades and compressor blades includes a ceramic matrix composite material.

In a further embodiment of any of the foregoing turbine engines, the intumescent material is disposed within a clearance between the corresponding one of the plurality of turbine blades, compressor blades and fan blades and a mounting slot formed within a corresponding turbine rotor, compressor rotor and fan rotor.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example gas turbine engine.

FIG. 2 is a schematic view of an example turbine rotor and turbine blade.

FIG. 3 is a cross-sectional view of a turbine blade installed with an example turbine rotor.

FIG. 4A is a schematic view of an example ceramic matrix composite turbine blade.

FIG. 4B is a schematic view of an example turbine blade including an intumescent material applied to a root portion.

FIG. 4C is a schematic view of the example turbine blade installed within a turbine rotor.

FIG. 4D is an example view of a completed turbine rotor assembly including the example turbine blade.

### DETAILED DESCRIPTION

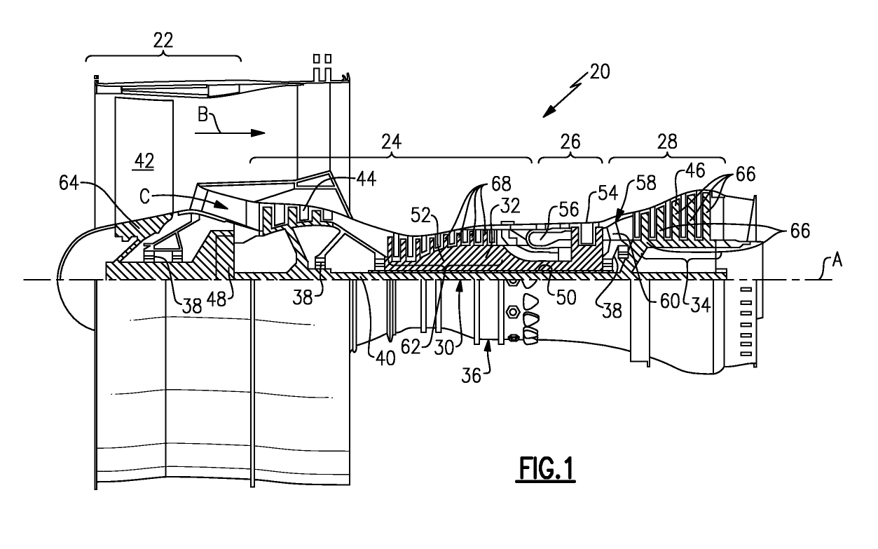

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 58 of the engine static structure 36 is arranged generally between the high pressure turbine 54 and the low pressure turbine 46. The mid-turbine frame 58 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 58 includes airfoils 60 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption ('TSFC')”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]0.5. The “Low corrected fan tip speed” as disclosed herein according to one non-limiting embodiment is less than about 1150 ft/second.

The example gas turbine engine includes the fan 42 that comprises in one non-limiting embodiment less than about twenty-six (26) fan blades. In another non-limiting embodiment, the fan section 22 includes less than about twenty (20) fan blades. Moreover, in one disclosed embodiment the low pressure turbine 46 includes no more than about six (6) turbine rotors schematically indicated at 34. In another non-limiting example embodiment the low pressure turbine 46 includes about three (3) turbine rotors. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

The example gas turbine engine includes the plurality of turbine rotors 34 that each supports a corresponding plurality of turbine blades 66. The compressor section also includes a plurality of compressor rotors 62 that support a corresponding plurality of compressor blades 68. The fan section 22 includes a fan rotor 64 that supports the plurality of fan blades 42.

The hotter sections of the example gas turbine engine require cooling features because the high energy exhaust gases create an environment where temperatures exceed material capabilities. Accordingly, ceramic matrix composite materials that have higher thermal capabilities are of great interest. However, the use of a ceramic matrix composite turbine blade is complicated due to the material properties of ceramic. Ceramic materials are brittle and do not respond well to point contacts. The relatively brittle nature of a ceramic component complicates mounting into a metal alloy rotor. Point contact between a metal mounting structure, such as a turbine rotor, and a ceramic turbine blade increases stresses within the ceramic turbine blade that reduces overall operational life of the ceramic matrix composite turbine blade.

Referring to FIG. 2, an example turbine rotor 34 is constructed of a metal material and includes a plurality of mounting slots 72. The mounting slots 72 include a shape that corresponds to a root portion 70 of a turbine blade 66. In this example, the turbine blade 66 is fabricated from a ceramic material. The blade material may also be an organic matric composite of aluminum or titanium. Moreover the material may also comprise any other temperature compatible composite materials. The example ceramic material is a ceramic matrix composite material that forms the root portion 70 as well as at least a portion of the airfoil 78 of the example turbine blade 66. The root portion 70 includes a shape that corresponds to the mounting slot 72 formed within the turbine rotor 34.

Because the example turbine blade 66 is formed from a ceramic matrix composite material, it is more brittle and susceptible to damage than a turbine blade constructed from a metal alloy material. Accordingly, the example turbine blade 66 utilizes an intumescent material 80. An intumescent material is material that expands upon exposure to heat. The expansion remains permanent in that the intumescent material will expand and remain in the expanded condition once the applied heat is removed.

In this example, the intumescent material 80 is spread onto the root portion 70 and is disposed within a clearance defined between inner surfaces 75 of the mounting slot 72 and the root portion 70 of the turbine blade 66.

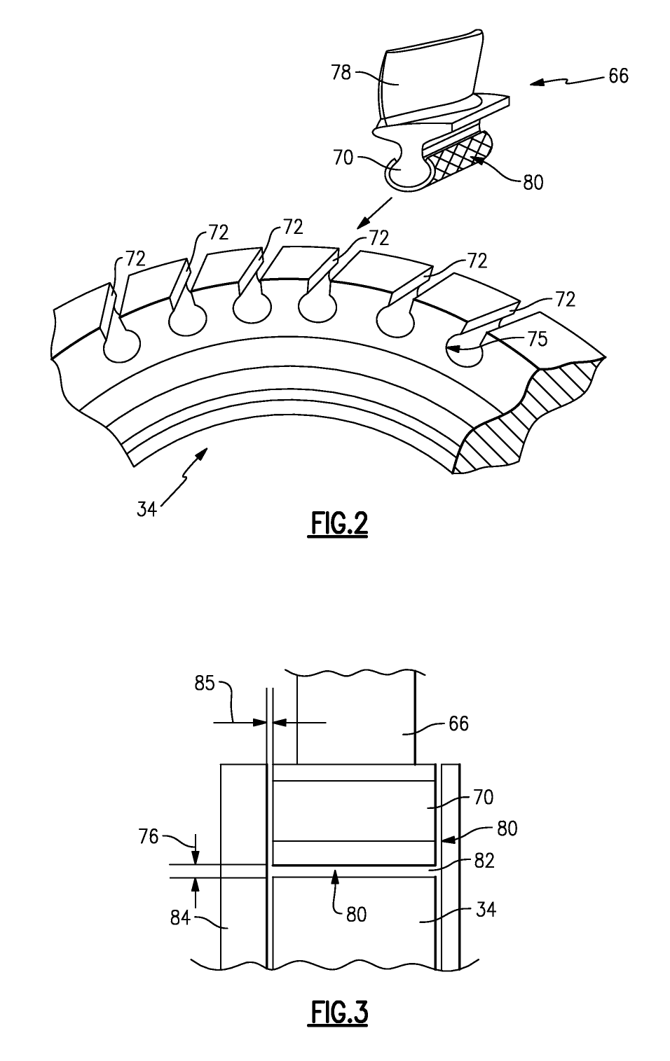

Referring to FIG. 3 with continued reference to FIG. 2, the intumescent material 80 is spread within a clearance 76 that is defined between the inner surfaces 75 of the mounting slot 72 and the root portion of the turbine blade 66. The clearance provides that no point contact is incurred or exerted onto the turbine blade 66. The intumescent material 80 fills the gaps and clearances defined between the mounting slot 72 and the root portion 70 of the turbine blade 66.

The mounting slot includes a forward stop 84 and an aft stop 82 for holding the turbine blade 66 within the mounting slot 72. A clearance 85 may also be present between the forward and aft stops 84, 82 that are filled with the intumescent material 80.

The intumescent material 80 filling the clearances defined between the mounting slots 72 and the root portion 70 provides a material that upon heating expands to fill the clearance 76 and any gaps that may be present. By filling the gaps and the clearance 76 with the intumescent material that expands to fill all gaps and clearances, no specific point contact is exerted on the root portion 80 of the turbine blade 66. Instead, a uniform contact is exerted between the mounting slot 72 and the root portion 70 of the turbine blade 66. The intumescent material forms a gasket between the ceramic matrix composite turbine blade 66 and the metal slots defined by the turbine rotor 34.

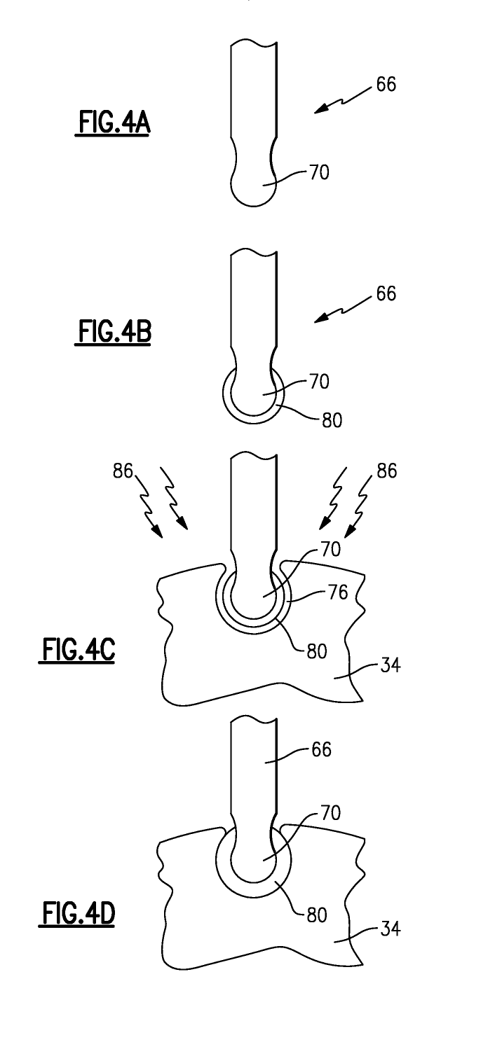

Referring to FIG. 4A with continued reference to FIGS. 2 and 3, an example turbine blade 66 is assembled to a turbine rotor 34 by first forming the ceramic turbine blade 66 from a ceramic matrix composite material. In this example, the entire blade 66 is formed from a ceramic matrix composite including the root portion 70. However, it is within the contemplation of this disclosure that the turbine blade 66 may also be comprised of a metal material or partially comprised of ceramic and metal materials. Moreover, while the disclosed mounting method is applicable and useful for mounting ceramic matrix composite turbine blades, it may also be utilized for metal alloy and blades formed from other materials.

Referring to FIG. 4B, the intumescent material 80 is applied to the root portion of the turbine blade 66. The intumescent material may be provided in a consistency that allows it to maintain and stick to the root portion 70 of the turbine blade 66. The intumescent material 80 may also be applied to the mounting slots 72.

Referring to FIG. 4C, the turbine blade 66 is shown mounted within the turbine blade mounting slot 72 in a condition where the intumescent material is in a contracted or original non-expanded condition. In this condition, a clearance 76 is disposed between the root portion 70 of the turbine blade 66 and the inner surfaces 75 of the mounting slot 72 defined within the turbine rotor 34. It should be appreciated, that the clearance 76 is exaggerated in the illustrated example, and would be smaller in practice to provide a desired fit between the root 70 and the slot 72.

Once the turbine blade 66 is assembled and is disposed within the corresponding mounting slot 72, heat schematically shown by arrows 86 is applied to the turbine blade 66, the rotor 34 and the intumescent material 80. Heating of the intumescent material 80 causes it to swell and expand to fill the clearance 76 as well as any gaps or inconsistencies within the connection and interface between the turbine blade 66 and the mounting slot 72.

The intumescent material 80 forms a gasket that forms a barrier between the mounting slot 72 and the root portion 70 of the turbine blade 66. The interface formed by the intumescent material 80 between the turbine blade 66 and the inner surfaces 75 of the mounting slot 72 provides a uniform contact pressure on the ceramic matrix composite turbine blade 66 that avoids formation of areas of high stress at any specific individual point along the root portion 70. A longer operational life of the turbine blade is provided by avoiding localized point contact and high stress areas.

Referring to FIG. 4D with continued reference to FIGS. 2 and 3, the example intumescent material 80 is shown in an expanded condition that locks the turbine blade 66 to the turbine rotor 34. The intumescent material 80 has expanded in response to the exposure to heat 86. Heating 86 can be accomplished prior to assembly into an engine. Heat may also be applied as part of an initial engine startup utilizing heat generated during operation.

It should be understood that although an example embodiment is explained as turbine blade 66 and rotor 34, it is within the contemplation of this disclosure that the fan blade 42 could mounted within the fan rotor 64 (FIG. 1) and/or the compressor blade 68 could be mounted within the compressor rotor 62 (FIG. 1) utilizing the intumescent material.

The interface provided by the intumescent material 80 between the turbine blade 66 and the turbine rotor 34 is permanent and does not recede. Accordingly, the turbine blade 66 is mounted permanently within the turbine rotor 34 until such time as the blades are removed or other routine maintenance.

Accordingly, the example mounting method and turbine rotor provides a means for mounting ceramic matrix composite turbine blades within a metal rotor that accommodates tolerances and inconsistencies between a metal retaining slot and rotor while also providing for the elimination of point contact along the ceramic material of the turbine blade.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A rotor assembly for a gas turbine engine comprising:
a rotor including a mounting slot;
a blade formed from a ceramic material and received within the mounting slot; and
an intumescent material disposed within the mounting slot between the blade and an inner surface of the mounting slot in an expanded condition for securing the blade within the mounting slot.

2. The rotor assembly as recited in claim 1, wherein a clearance is provided between the blade and the inner surface of the mounting slot and the intumescent material is disposed within the clearance.

3. The rotor assembly as recited in claim 2, wherein the intumescent material is expanded within the clearance to fill inconsistences in the blade and the inner surface of the mounting slot.

4. The rotor assembly as recited in claim 1, wherein the mounting slot includes a shape configured for retaining the blade and the blade includes a corresponding shape for receipt into the slot.

5. The rotor assembly as recited in claim 1, wherein the rotor includes a forward stop and an aft stop for preventing axial movement of the blade and the intumescent material is disposed on corresponding forward and aft surfaces of the blade.

6. The rotor assembly as recited in claim 1, wherein the rotor comprises a turbine rotor and the blade comprises a turbine blade.

7. The rotor assembly as recited in claim 1, wherein the rotor comprises a compressor rotor and the blade comprises a compressor blade.

8. The rotor assembly as recited in claim 1, wherein the rotor comprises a fan rotor and the blade comprises a fan blade.

9. The rotor assembly as recited in claim 1, wherein the blade includes a blade root received within the mounting slot and at least the blade root is formed from a ceramic material.

10. The rotor assembly as recited in claim 9, wherein the ceramic material comprises a ceramic matrix composite.

11. The rotor assembly as recited in claim 1, wherein the rotor comprises a metal material.

12. A method of fabricating a rotor assembly of a gas turbine engine comprising:
applying an intumescent material to one of a blade mounting surface and an inner surface of a mounting slot of a rotor;
assembling a blade into the mounting slot; and
expanding the intumescent material by heating to fill a clearance between the blade mounting surface and the inner surface of the mounting slot.

13. The method as recited in claim 12, including fabricating a blade from a ceramic material.

14. The method as recited in claim 12, including fabricating the blade from a ceramic matrix composite.

15. The method as recited in claim 14, including forming the rotor from a metal material.

16. The method as recited in claim 15, including defining a clearance between the mounting slot of the rotor and the mounting surface of the rotor and filling the clearance with the intumescent material.

17. The method as recited in claim 16, including heating the rotor, blade and intumescent material to expand the intumescent material and secure the blade within the mounting slot.

18. A turbine engine comprising:
a fan section including a fan rotor supporting a plurality of fan blades rotatable about an axis;
a compressor section, including a compressor rotor supporting a plurality of compressor blades;
a combustor in fluid communication with the compressor section; and
a turbine section in fluid communication with the combustor, the turbine section including a turbine rotor supporting a plurality of turbine blades; and
an intumescent material in an expanded condition securing at least one of the plurality of turbine blades, compressor blades and fan blades within a corresponding one of the turbine rotor, compressor rotor and fan rotor.

19. The turbine engine as recited in claim 18, wherein the at least one of the plurality of turbine blades and compressor blades comprises a ceramic matrix composite material.

20. The turbine engine as recited in claim 18, wherein the intumescent material is disposed within a clearance between the corresponding one of the plurality of turbine blades, compressor blades and fan blades and a mounting slot formed within a corresponding turbine rotor, compressor rotor and fan rotor.
